(19) United States
(12) Patent Application Publication
(10) Pub. No.: US 2013/0268375 A1
(43) Pub. Date: Oct. 10, 2013

(54) Identifying the Physical Location of Internet Service Providers

(71) Applicant: BLIS MEDIA LIMITED, London (GB)

(72) Inventor: Gregor Donald Isbister, London (GB)

(73) Assignee: Blis Media Limited, London (GB)

(21) Appl. No.: 13/857,338

(22) Filed: Apr. 5, 2013

(30) Foreign Application Priority Data
Apr. 5, 2012 (GB) 12 06 254.3

(51) Int. Cl. G06F 17/30

(52) U.S. Cl. CPC G06F 17/30424
USPC 705/14.71; 707/769

(57) ABSTRACT

Apparatus and methods are provided for identifying the physical location of internet service providers. Requests for data are received from a plurality of locatable browsing clients that include the IP address of the internet service provider that each of the locatable browsing clients is connected to, and geolocation data identifying the physical location of each of the plurality of locatable browsing clients. These requests are stored in records in a first database. A query is then performed on the first database to identify records where the originating IP addresses match and the geolocation data match within a threshold range; the results of the query are then stored in records in a second database. The records in the second database can then be used to provide location-specific data to clients in a web server implementation, or make bids on advertising opportunities based upon a browsing client's location.

### CROSS REFERENCE TO RELATED APPLICATIONS

This application claims priority from United Kingdom patent application number 12 06 254.3 filed Apr. 5, 2012, the whole contents of which are incorporated herein by reference in their entirety.

### BACKGROUND OF THE INVENTION

1. Field of the Invention

The present invention relates to a method of, and an apparatus for, identifying the physical locations of internet service providers. In addition, the present invention relates to applications in a web service environment of the locations of the internet service providers.

2. Description of the Related Art

Location-based services are becoming increasingly commonplace methodologies for delivering content to users, particular those who use mobile devices. In particular, publishers commonly wish to provide users with more relevant content in view of their current location—examples of such content being bespoke, dynamically-generated web pages specific to a particular location, and advertising. For instance, a publisher may produce regional or even city-based news stories, and may wish to know a users present location such that they are presented with relevant news. Advertising may need to be presented on a location-specific basis—it would be no good, say, for a user browsing a web page in a first city to be presented with advertising for events occurring in a second city.

Whilst some mobile devices are now location-aware, which is to say they have Global Positioning System (GPS) or similar functionality, and can therefore generate geolocation data, only a small fraction actually give up this data to third parties. An even larger number simply do not have GPS functionality.

Present solutions to the problem of associating a physical location with a mobile device (operating as a browsing client) that does not provide geolocation data, examples of said solutions including IP address-based location services, involve identifying the browsing client's IP address, and performing a lookup query on a database to identify the owner of the IP address block. This can oftentimes result in the generation of a location far from where the browsing client actually is. If a decision to serve content to a browsing client is made upon the back of this query, then it is highly likely that the actual content vended has little relevance when the browsing client's actual physical location is taken into account.

### BRIEF SUMMARY OF THE INVENTION

According to an aspect of the present invention, there is provided apparatus configured to identify the physical location of internet service providers that each have distinct originating IP addresses, said apparatus comprising a storage device, a network interface, and a processor configured to: receive a plurality of requests for data from a plurality of locatable browsing clients via said network interface, said requests including an originating IP address corresponding to the internet service provider that each said plurality of browsing clients is connected to, and geolocation data identifying the physical location of each of said plurality of browsing clients; create and store, in a first database in said storage device, a plurality of records containing said originating IP address and said geolocation data for each of said plurality of request; perform a query on said first database to identify records where the originating IP addresses match and the geolocation data match within a threshold range; creating a second database in said storage device, and storing the results of said query in records in said second database.

According to another aspect of the present invention, there is provided a computer-implemented method of identifying the physical location of internet service providers, each of which has a distinct originating IP address, comprising: receiving a plurality of requests for data from a first plurality of locatable browsing clients, said plurality of requests for data including an originating IP address and geolocation data; storing records in a first database containing the originating IP address and the geolocation data for each one of said plurality of requests for data; performing a query on said first database that identifies records where the originating IP addresses match and the geolocation data matches within a threshold range; storing the results of said query in records in a second database.

A computer-implemented method of bidding on advertising opportunities in a Real Time Bidding environment, comprising: (i) identifying the physical location of internet service providers, each of which has a distinct originating IP address, by: receiving a plurality of requests for data from a first plurality of locatable browsing clients, said plurality of requests for data including an originating IP address and geolocation data, storing records in a first database containing the originating IP address and the geolocation data for each one of said plurality of requests for data, performing a query on said first database that identifies records where the originating IP addresses match and the geolocation data matches within a threshold range, storing the results of said query in records in a second database; and (ii) bidding on an advertising opportunity by: receiving a notification to the effect that an advertising opportunity exists in data that is to be served to a browsing client, said notification including the IP address of the internet service provider of the browsing client, performing a query on said second database to identify the geolocation data for said originating IP address, thereby identifying the physical location of said browsing client, in response to determining that the physical location of said browsing client is a location of interest, entering a bid for advertising to be included in said data to be served to said browsing client.

### BRIEF DESCRIPTION OF THE DRAWINGS

FIG. 1 shows an environment in which the present invention can be used;

FIG. 2 is an illustration of the scarcity of requests from browsing clients that contain geolocation data;

FIG. 3 shows an example of an apparatus for implementing the present invention as a web server 301;

FIG. 4 shows a Real Time Bidding (RTB) environment;

FIG. 5 shows an example of an apparatus for implementing the present invention as an RTB computer 501;

FIG. 6 shows procedures carried out by either web server 301 or RTB computer 501, to identify the physical location of Internet Service providers;

FIG. 7 illustrates a first database;

FIG. 8 shows procedures for validating the records in the first database, to produce a second database;

FIG. 9 illustrates the second database;

FIG. 10 shows the flow of data between a server and a mobile device to allow further validation of records in the second database;

FIG. 11 shows a procedure for location-aware web serving;

FIG. 12 shows a procedure for location-aware RTB environment bidding;

FIG. 13 shows a cellular network;

FIG. 14 shows a procedure for assigning IP addresses to mobile devices to allow location-aware RTB environment bidding; and

FIG. 15 shows a procedure for bidding on advertising opportunities in an RTB environment in the context of a cellular network.

### DETAILED DESCRIPTION OF EXAMPLE EMBODIMENTS

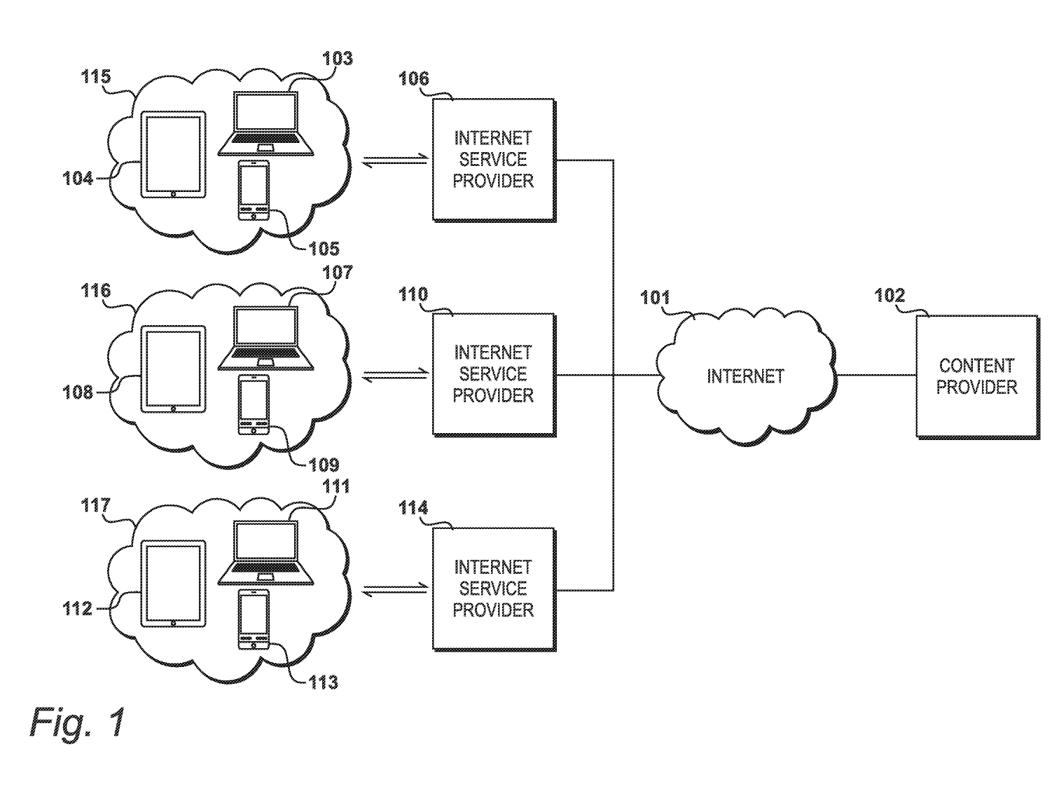

### FIG. 1

An exemplary environment suitable for deploying the technical principles embodied by the present invention is illustrated in FIG. 1.

Connected by the Internet 101 are a content provider 102, which provides web content such as web pages, videos and images, and a number of client devices. Each client device, in this case, is connected via an internet service provider (ISP) using wireless networking technologies, such as 802.11b/g. Thus, client devices 103, 104 and 105 are connected to the Internet 101 by means of ISP 106; client devices 107, 108 and 109 are connected to the Internet 101 by means of ISP 110; and client devices 111, 112 and 113 are connected to the Internet 101 by means of ISP 114. In this example, each of ISPs 106, 110 and 114 provides Internet access to connected client devices at a particular location. Thus, client devices 103, 104 and 105 may be connecting to ISP 106 at a hotel, for instance. This type of service is commonly referred to as a “wireless hotspot”, and thus creates wireless hotspots 115, 116 and 117, with ISPs offering Internet access to client devices so as to allow web browsing, email access and so on. In this example, ISP 106 provides Internet access to client devices at a location distinct from ISP 110, ISP 110 provides Internet access to client devices at a location distinct from ISP 114, and so on.

In present times, there has become a demand in the marketplace for location-aware content. For instance, users may wish to receive content that is only relevant to them in their present location. Furthermore, content providers themselves may only wish to provide particular content to client devices at particular locations. A further need for location-aware generation of content exists in terms of not providing content to users in particular locations, thus allowing a greater degree of control over the distribution of content.

The present invention has a particular aim in the sort of scenario illustrated in FIG. 1: to enable more fine-grained provision of location-specific content to more users.

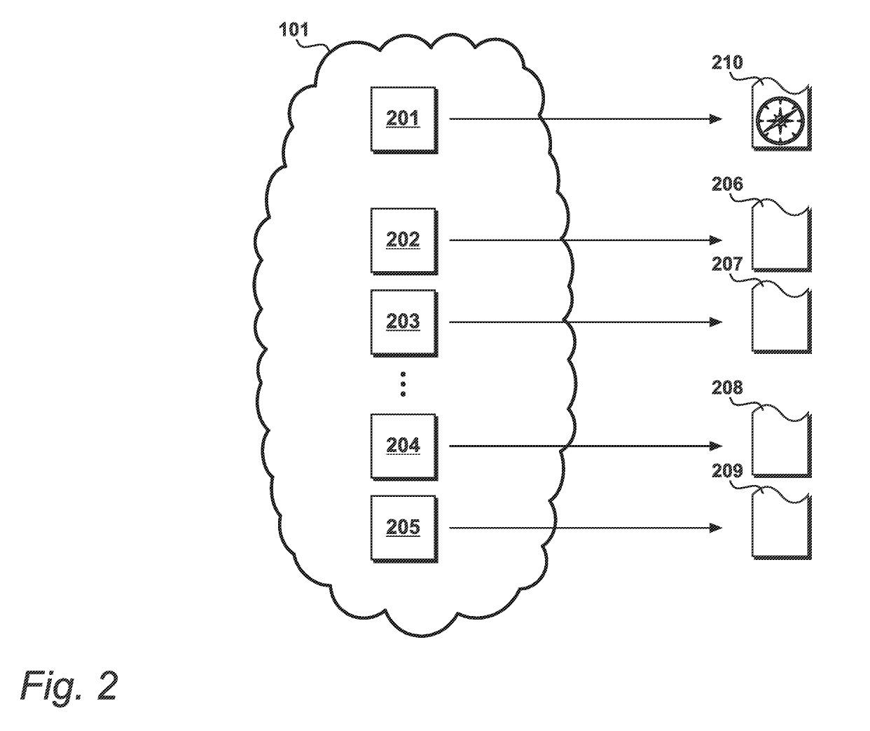

### FIG. 2

As will be appreciated by those skilled in the art, not all client devices have functionality that allows the provision, to a content provider, of their present location. FIG. 2 illustrates this problem diagrammatically.

A number of devices 201, 202, 203, 204 and 205 form part of the Internet 101, each possibly being connected to a wireless hotspot, such as those described previously with respect to FIG. 1. Each one of these devices sends out requests whenever they require data of some form—for example, they may be requesting an initial webpage HTML document using HTTP, or may, having received that HTML document, be requesting further resources required to display the webpage correctly, such as images, video or advertising.

Most of these requests, such as request 206 issued by device 202, request 207 issued by device 203, request 208 issued by device 204, and request 209 issued by device 205, contain only information concerning the Internet-facing IP address of the client device, the device type, the browser type and so forth. However, (as found in research conducted by the present applicant), in around five percent of cases, requests may include geolocation data, such as request 210 issued by device 201. Device 201 can therefore be characterised as a locatable browsing client. In many cases, this geolocation data comprises latitude and longitude co-ordinates generated by GPS-based technology present in the device. Other geolocation data that can be provided includes orientation (provided by a magnetometer or a compass) and altitude (either provided by GPS or an altimeter).

Thus, at first sight, it may seem, therefore, that only five percent of requests can be responded to with content that is sympathetic to a device's location.

However, the present applicant has recognised that in the case of ISP-owned wireless hotspot, such as those operated in the context of FIG. 1 by ISPs 106, 110 and 114, location-aware content can be provided to any and all client devices. Each wireless hotspot, such as wireless hotspots 115, 116 and 117, utilises some form of router to allow its connected client devices to access the Internet 101. Such routers often utilise Network Address Translation, such that devices connected on the local area network side of the router, whilst each having a distinct Internet Protocol (IP) address, appear from the wide area network side of the router to have the same IP address—the IP address of the router. Thus, referring to FIG. 1, it is clear from this knowledge that each one of the devices 103, 104 and 105 that are connected to ISP 106 will, from the perspective of content provider 102, appear to have the distinct originating IP address of the router operating the wireless hotspot operated by ISP 106. As the router is practically guaranteed to remain in a particular location, it is possible to therefore associate a particular location with a particular IP address, irrespective if the requests from the client devices themselves actually include geolocation data.

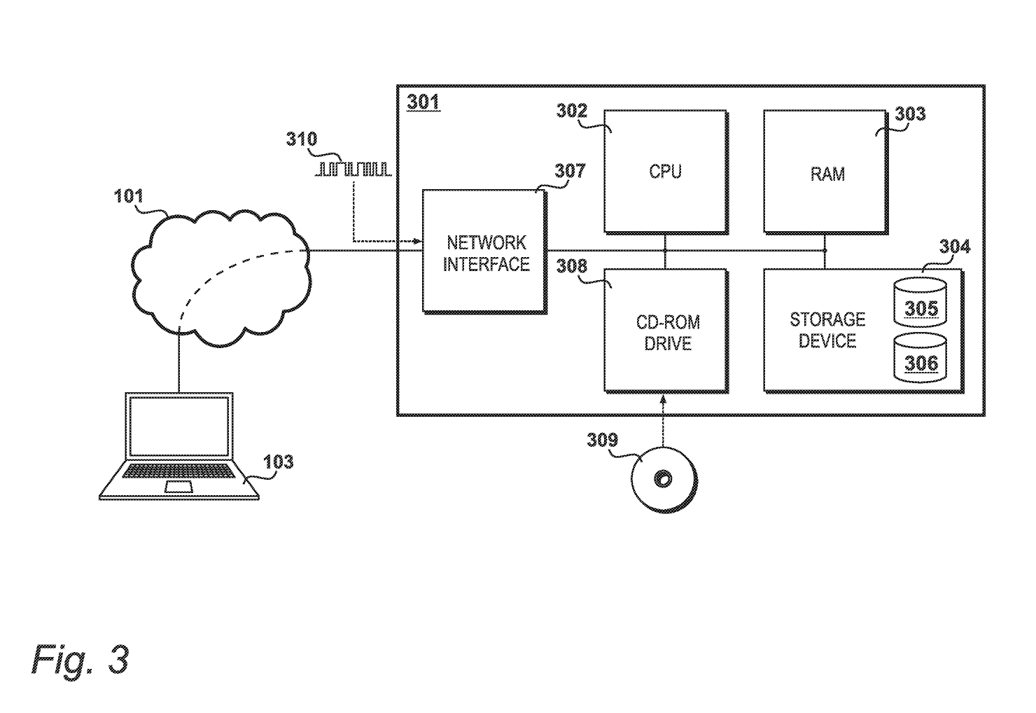

### FIG. 3

Thus, a first embodiment for an apparatus that can make use of this realisation in a technical approach to solving the problem of providing location-based content, is illustrated in FIG. 3. In this first embodiment, the apparatus is adapted to operate as a location-aware web server 301. Upon receiving a request from a client device having an IP address with an associated known location, appropriate content can be served by web server 301.

In order for web server 301 to execute instructions, it comprises a processor such as central processing unit (CPU) 302. In this instance, CPU 302 is a single Intel® Xeon® processor. It is possible that in other configurations several such CPUs will be present to provide a high degree of parallelism in the execution of instructions.

Memory is provided by 8 gigabytes of DDR3 random access memory (RAM) 303, which allows storage of frequently-used instructions and data structures by web server 301. A portion of RAM 303 is reserved as shared memory, which allows high speed inter-process communication between applications running on web server 301.

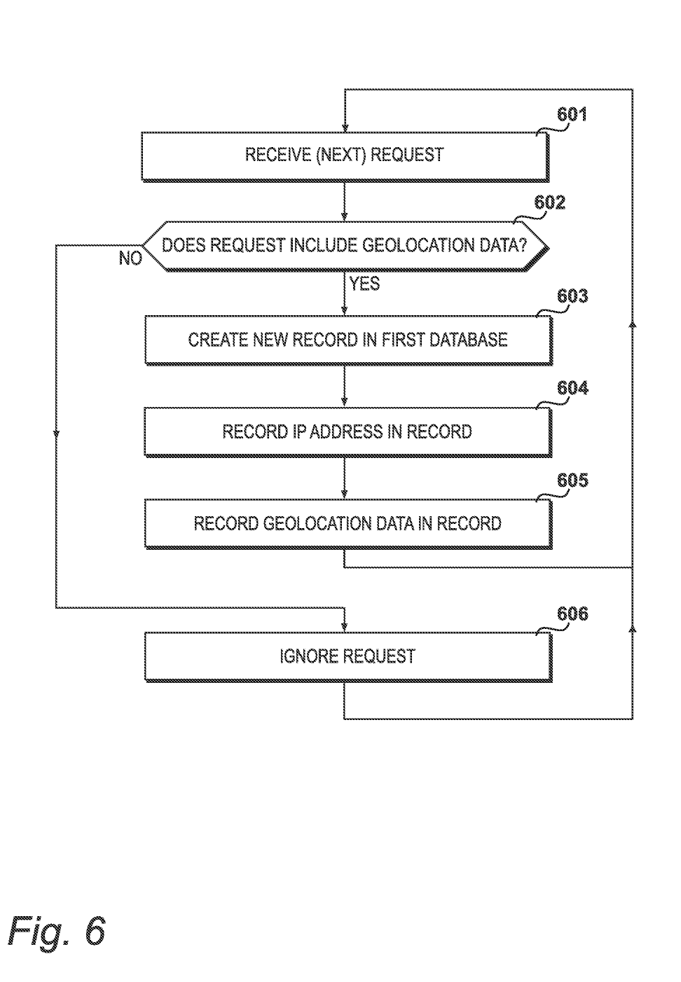

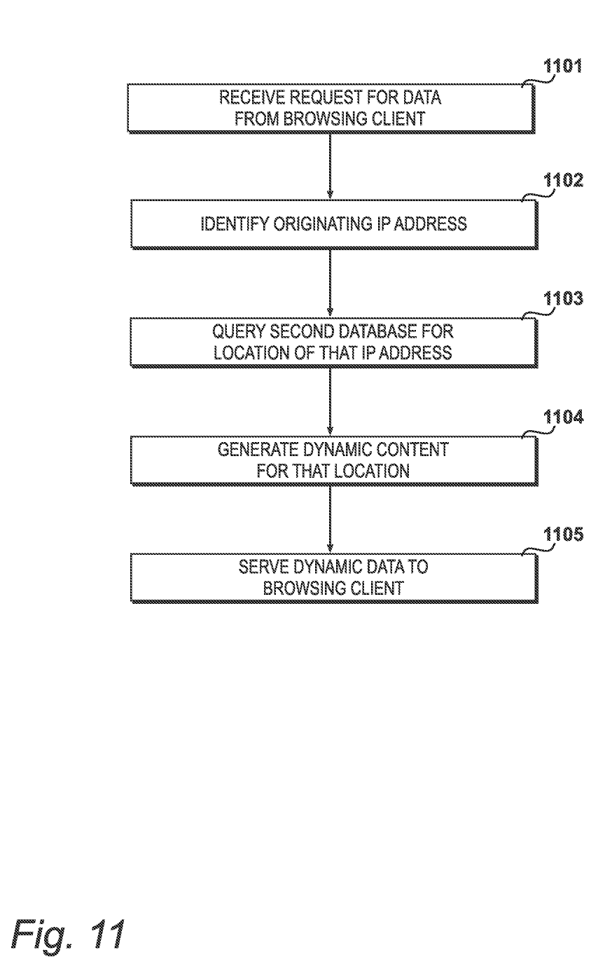

Permanent storage is provided by a storage device such as hard disk drive 304, which in this instance has a capacity of 1 terabyte. Hard disk drive 304 stores operating system and application data, along with a number of databases, illustrated in this Figure as first database 305 and second database 306. The content of these databases is generated by processes expanded upon with reference to FIGS. 6 to 10, whilst the use of them is expanded upon with reference to FIGS. 11 to 15. In alternative embodiments, a number of hard disk drives could be provided and configured as a RAID array to improve data access times. Hard disk drive 303 contains a list having information pertaining to which data files' transfer is to be monitored and verified, along with a list of characteristics of these data files.

A network interface 307 allows web server 301 to connect to the Internet 101, possibly via an internal network and a router (not shown), and provide content to a browsing client in response to its requests, such as client device 103 previously referenced with respect to FIG. 1. It will be appreciated that some of these requests, as explained with reference to FIG. 2, will include geolocation data in addition to just the browsing client's IP address etc. Network interface 307 also allows an administrator to interact with and configure web server 301 via another computer using a protocol such as secure shell.

Web server 301 also comprises an optical drive, such as a CD-ROM drive 308, into which an optical disk, such as a CD-ROM 309 can be inserted. CD-ROM 309 comprises computer-readable instructions that are installed on hard disk drive 304, loaded into RAM 303 and executed by CPU 302. Alternatively, the instructions (illustrated as 310) may be transferred from a network location using network interface 307.

It is to be appreciated that the above system is merely an example of a configuration of system that can fulfil the role of web server 301. Any other system having a processor, memory, and a network interface could equally be used. Indeed, web server 301 could be deployed as a virtual appliance on a virtualization platform hypervisor.

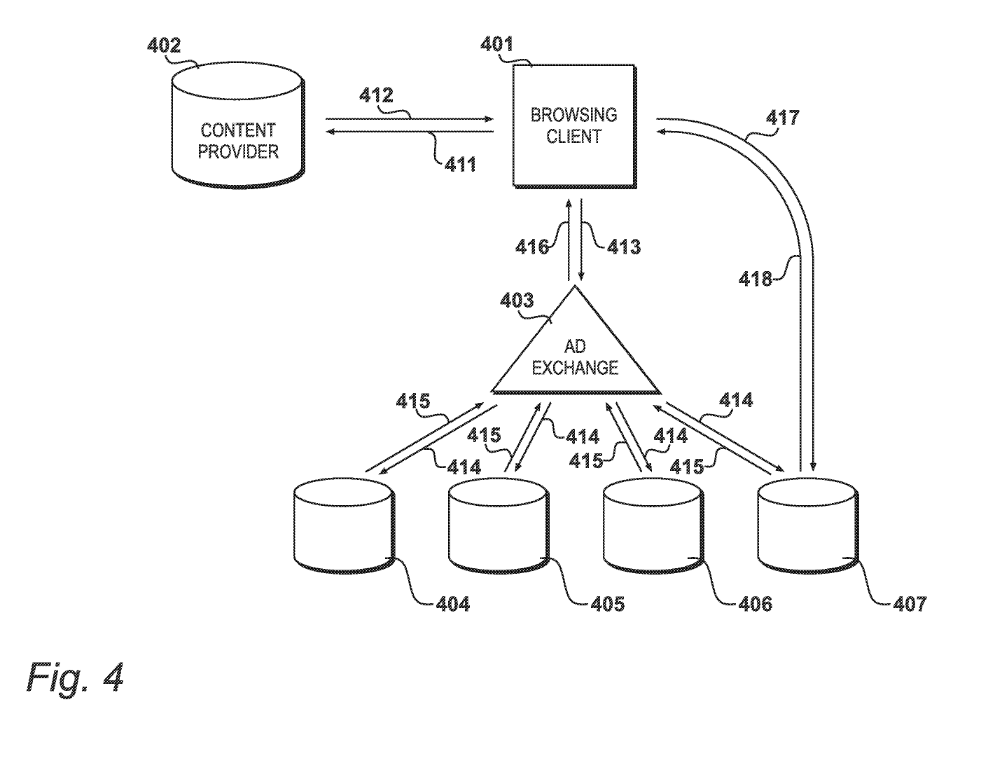

### FIG. 4

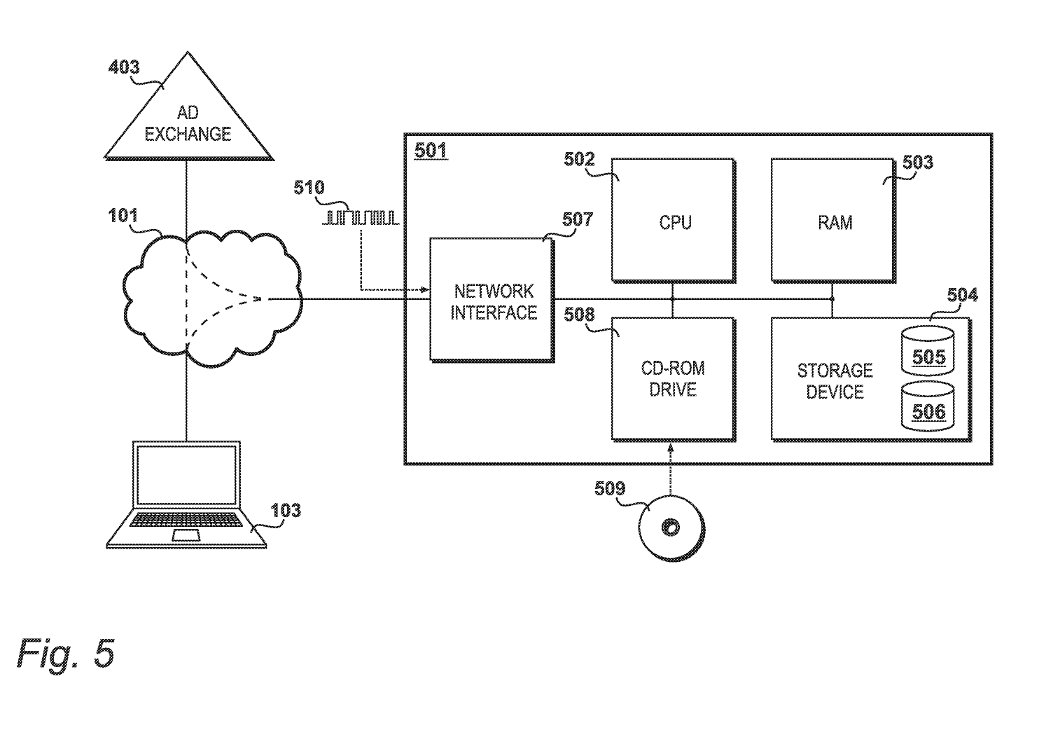

An alternative embodiment of an apparatus that can make use of the principles of the present invention is shown as part of a Real Time Bidding environment in FIG. 4. The contents of such an apparatus will be expanded upon with reference to FIG. 5.

As will be appreciated by those skilled in the art, Real Time Bidding is a relatively new method of selling and purchasing advertising for display on a web page. This selling and purchasing is done in real time, and on a per-impression basis. Referring to FIG. 4, the way in which this operates will now be described.

A browsing client 401 makes a request at 411 for some content, such as a web page, from a content provider 402. The content provider supplies the HTML (or similar) for the web page to the browsing client at 412. Included in the code of the web page, is a pointer (known in the art as an “ad tag”) to resource hosted by an advertising exchange 403. Thus, at 413, the browsing client makes a request to the advertising exchange for the resource—i.e. the image or video to show as part of an advertisement on the web page. Importantly, this request to the advertising exchange includes data concerning the client, and, as described previously with reference to FIG. 2, in a small proportion of cases this includes geolocation data.

After receiving this request, the advertising exchange 403 issues auction notifications at 414 to each one of a number of participants in the Real Time Bidding Environment—namely participants 404, 405, 406 and 407. The notification includes the data about the browsing client that the advertising exchange received, so as to allow the participants to make an informed choice on the potential value of the advertising impression they are about to bid on. Each participant thus makes a decision as to whether to bid on the opportunity to present their advertising to the browsing client, and return their responses at 415. In this example, participant 407 wins the auction, and so advertising exchange 403 returns to browsing client 401 at 416 the location of a resource hosted by participant 407. At 417, browsing client 401 requests the resource (i.e. the data constituting an advertisement) from participant 407, which serves the data to the browsing client at 418.

### FIG. 5

Illustrated in FIG. 5 is an example of an apparatus that can be used by a participant in the Real Time Bidding environment described previously with reference to FIG. 4.

Thus, in this second embodiment, the apparatus is adapted to operate as a Real Time Bidding (RTB) computer 501. Upon receiving an auction notification from advertising exchange 403 including an IP address with an associated known location, appropriate bids on the advertising impression can be made by RTB computer 501.

In order for RTB computer 501 to execute instructions, it comprises a processor such as central processing unit (CPU) 502. In this instance, CPU 502 is a single Intel® Xeon® processor. It is possible that in other configurations several such CPUs will be present to provide a high degree of parallelism in the execution of instructions.

Memory is provided by eight gigabytes of DDR3 random access memory (RAM) 503, which allows storage of frequently-used instructions and data structures by RTB computer 501. A portion of RAM 503 is reserved as shared memory, which allows high speed inter-process communication between applications running on RTB computer 501.

Permanent storage is provided by a storage device such as hard disk drive 504, which in this instance has a capacity of one terabyte. Hard disk drive 504 stores operating system and application data, along with a number of databases, illustrated in this Figure as first database 505 and second database 506. The content of these databases is generated by processes expanded upon with reference to FIGS. 6 to 10, whilst the use of them is expanded upon with reference to FIGS. 11 to 15. In alternative embodiments, a number of hard disk drives could be provided and configured as a RAID array to improve data access times. Hard disk drive 503 contains a list having information pertaining to which data files' transfer is to be monitored and verified, along with a list of characteristics of these data files.

A network interface 507 allows RTB computer 501 to connect to the Internet 101, possibly via an internal network and a router (not shown), and provide advertising content to a browsing client, such as client device 103 previously referenced with respect to FIG. 1, and also to receive auction notifications from advertising exchange 403. It will be appreciated that some of these auction notifications, as explained with reference to FIG. 2 and FIG. 4, will include geolocation data in addition to just the browsing client's IP address etc. Network interface 507 also allows an administrator to interact with and configure web server 501 via another computer using a protocol such as secure shell.

RTB computer 501 also comprises an optical drive, such as a CD-ROM drive 508, into which an optical disk, such as a CD-ROM 509 can be inserted. CD-ROM 509 comprises computer-readable instructions that are installed on hard disk drive 504, loaded into RAM 503 and executed by CPU 502. Alternatively, the instructions (illustrated as 510) may be transferred from a network location using network interface 507.

It is to be appreciated that the above system is merely an example of a configuration of system that can fulfil the role of RTB computer 501. Any other system having a processor, memory, and a network interface could equally be used. Indeed, RTB computer 501 could be deployed as a virtual appliance on a virtualization platform hypervisor.

### FIG. 6

Procedures carried out by either web server 301 or RTB computer 501, following the instructions loaded onto them, are illustrated in FIG. 6. These particular procedures allow the identification of the physical location of ISPs, such as ISPs 106, 110 and 114, each of which has a distinct IP address.

At step 601, a request for data is received. It will be appreciated by those skilled in the art that in the context of these procedures being carried out by web server 301, the request will be a HTTP request for some content. Many devices' web browsers are beginning to implement the Geolocation API, which allows the provision to web servers of geolocation data so as to allow location-aware services to be provided to users. Using this system, GPS co-ordinates are encapsulated in a JavaScript® Object Notation (JSON) object and sent using HTTP POST techniques. Alternative standard methodologies for conveying geolocation data between a client device and a server exist, and are typically well-defined for the particular domain of the service being requested by the client. Thus, the present invention includes provisions for, on a domain-by-domain basis, locating and reading the location included in requests issued by the client device. For instance, certain web-based services, such as weather forecasting applications, exist only on a particular domain. Location-aware client devices always convey their geolocation data to the service in a particular way. Thus, the present invention includes provisions for extracting this geolocation data from the request, as it is a known fact that the location data will be present in requests from client devices to that service at a particular place in the request.

In alternative cases, however, the geolocation data encapsulated by the client device in its request may not conform to well-defined standards as specified by systems similar to and including the Geolocation API. Thus, the present invention includes provisions for taking a holistic approach to identifying latitude and longitude co-ordinate data that may be included in a request, said co-ordinate data forming part of either query strings in URLs or request headers themselves, which are able to be inspected.

In the context of RTB computer 501, the request received will be the data concerning the browsing client from an advertising exchange, which may include geolocation data as previously described.

It will be appreciated to those skilled in the art that in the context of the present invention, the term “request” is not only limited to, for instance, HTTP requests. Other types of request for data issued over a network in conformance with a protocol (such as those forming part of the Internet Protocol Suite, say TCP or UDP, or protocols that run on top of these, such as WebSocket) can, in the present invention, serve as a basis for allowing the location of a client device to be identified. Further, such requests may form part of a stateful connection in addition to those that form part of a stateless connection.

At step 602, a question is asked as to whether the received request includes geolocation data. If answered in the affirmative, then a new record is created in the first database (either first database 305 or 505) at step 603. The originating IP address revealed by the client in the request (i.e. the Internet-facing IP address of the router they are connecting to the Internet through) is recorded in the record at step 604, and at step 605 the geolocation data is stored in the record as well.

If the question asked at step 602 was answered in the negative, then at this stage control proceeds to step 606 where the request is ignored, and control returns to step 601 where another request can be received and processed.

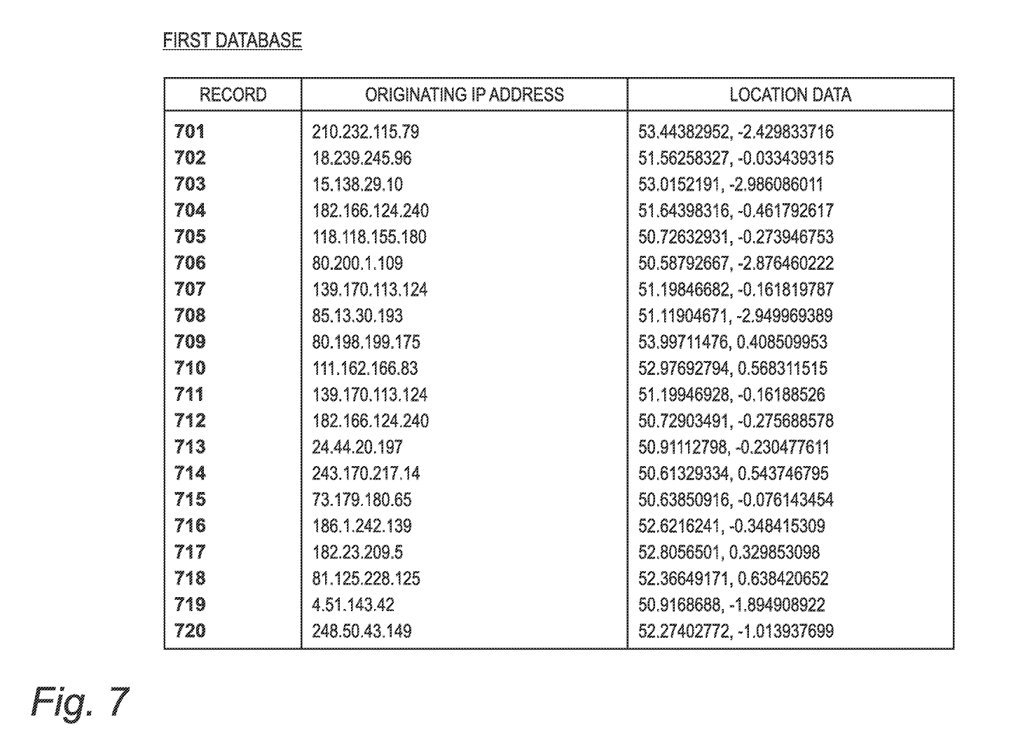

### FIG. 7

The procedures set out in FIG. 6 result in the generation of a first database (either first database 305 or 505), as illustrated in FIG. 7.

Each record, in this example records 701 to 720, stores in the first database the distinct originating IP address provided by the client. In addition, the geolocation data, in this example latitude and longitude co-ordinates, is stored as well. Thus, a database is created that defines the locations of a plurality of distinct IP addresses.

As can be seen, records 704 and 712, and records 707 and 711 have matching IP addresses, and locations that are very similar. On a large scale, patterns like this suggest with a good degree of certainty that the location of those matching IP addresses is as defined by the geolocation data.

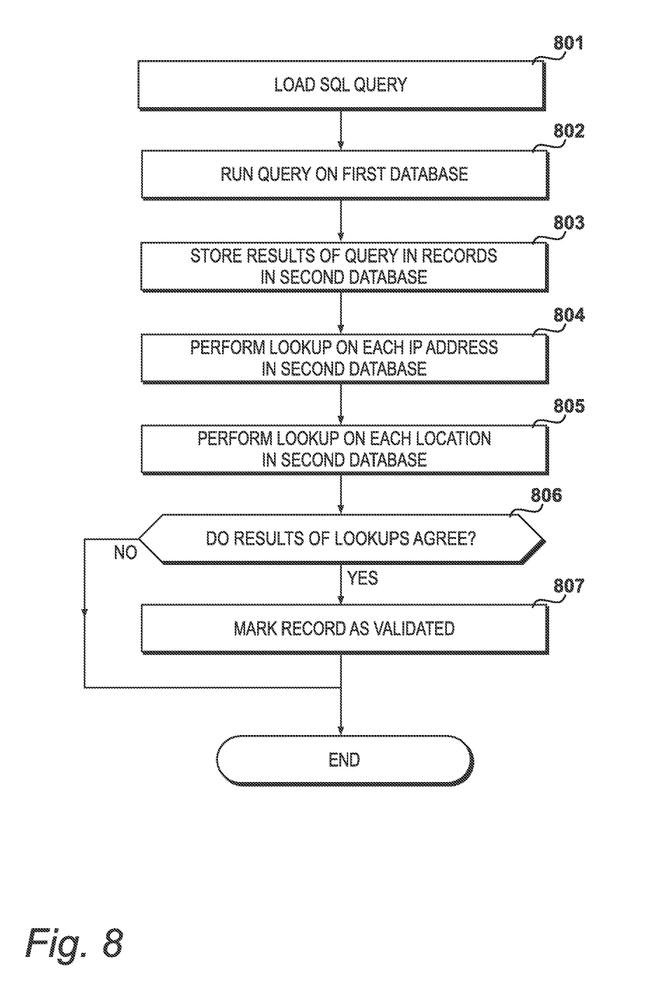

### FIG. 8

Thus, the present invention performs a degree of validation on such matching records to ascertain firstly whether they are correct and can be used in decision making by web server 301 or RTB computer 501, and secondly what exactly the nature of the service at that location is. Procedures carried out by either apparatus to achieve these aims are therefore illustrated in FIG. 8.

At step 801, an SQL query is loaded to identify records where the originating IP address match, and where the geolocation data matches within a threshold range. In an example, the SQL query is structured as follows: SELECT COUNT (IP Address) FROM First Database WHERE LOCATION RANGE=‘5’. In this example, the threshold range is defined as five metres, such that matching IP addresses with geolocation data identifying locations clustered within five metres of one another will be returned by the query. In an embodiment, the query also includes suitable code such that there must be a specific number of such matching results so as to rule out coincidences in the data—such a number is, in a specific embodiment, 100. This can be varied, however, and can be fine-tuned so as to strike an acceptable balance between accuracy and probability of results actually being output.

Thus, at step 802, the SQL query is performed on the first database, and the results are then stored in records in a second database (i.e. second database 306 in the context of web server 301, or second database 506 in the context of RTB computer 302). During this storing process, the geolocation data can either be averaged or a particular geolocation datum can be picked at random to reside in record the second database.

Following this population of the second database, at step 804 a lookup is performed on each distinct IP address in the second database using an Internet-based WHOIS service. This identifies the owner of the IP address stored in the record, and thus this data is also stored in the corresponding record in the second database.

At step 805, another lookup is performed on the location for each distinct IP address in the second database using an Internet-based place identification service, such as a Places API. This identifies the nature of the service at the particular location stored in the record, and thus this data is also stored in the corresponding record in the second database.

At step 806, a question is asked as to whether the results of the lookups agree. If answered in the affirmative, then the record is marked validated at step 807, and can then be used to make decisions in respect of web serving or Real Time Bidding. If answered in the negative, then the record is left as unvalidated. This could be due to the Places API returning more than one match for the particular location, and thus the nature of the service cannot be identified.

An alternative method for identifying IP addresses involves firstly generating a list of places of interest that are likely to have associated internet service providers. These places of interest can be defined by geofence polygons, which can be run against the first database to look for matches. If records are seen which have the same IP address and all reside within a polygon for a particular place of interest, then with some certainty that IP address can be correlated to that place of interest. However, if a record with that IP address has a location outside the polygon, then there is no correlation and that IP address can then be ruled out as being tied to the place of interest.

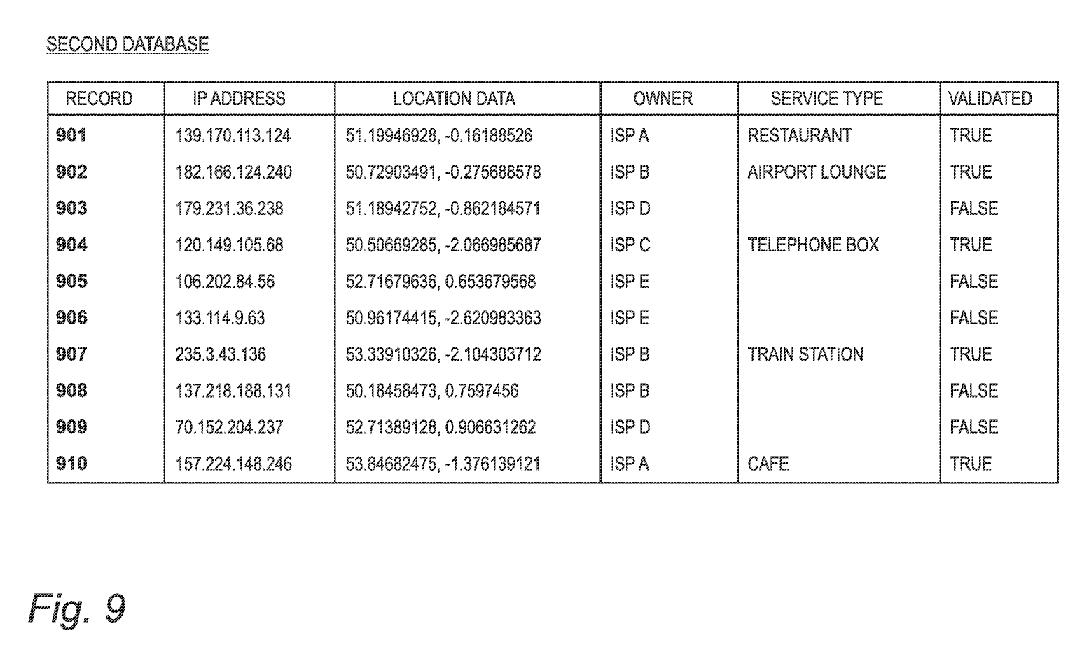

### FIG. 9

The procedures set out in FIG. 8 result in the generation of a second database (either second database 306 or 506), as illustrated in FIG. 9.

Each one of records 901 to 910 stored in the second database is the result of performing the query used in step 802. Following step 805, each record has been assigned an owner (i.e. the company responsible for operating the wireless hotspots). Following step 806, some of the records, records 901, 902, 904, 907 and 910, have been assigned a service type. Those that match have been marked as TRUE in the Validated column.

The present applicant has appreciated that a large number of records may never be marked as validated, as Places APIs may never be able to provide unambiguous data regarding the nature of the service at a queried location. Thus, a mobile application has been devised to allow the validation of these records.

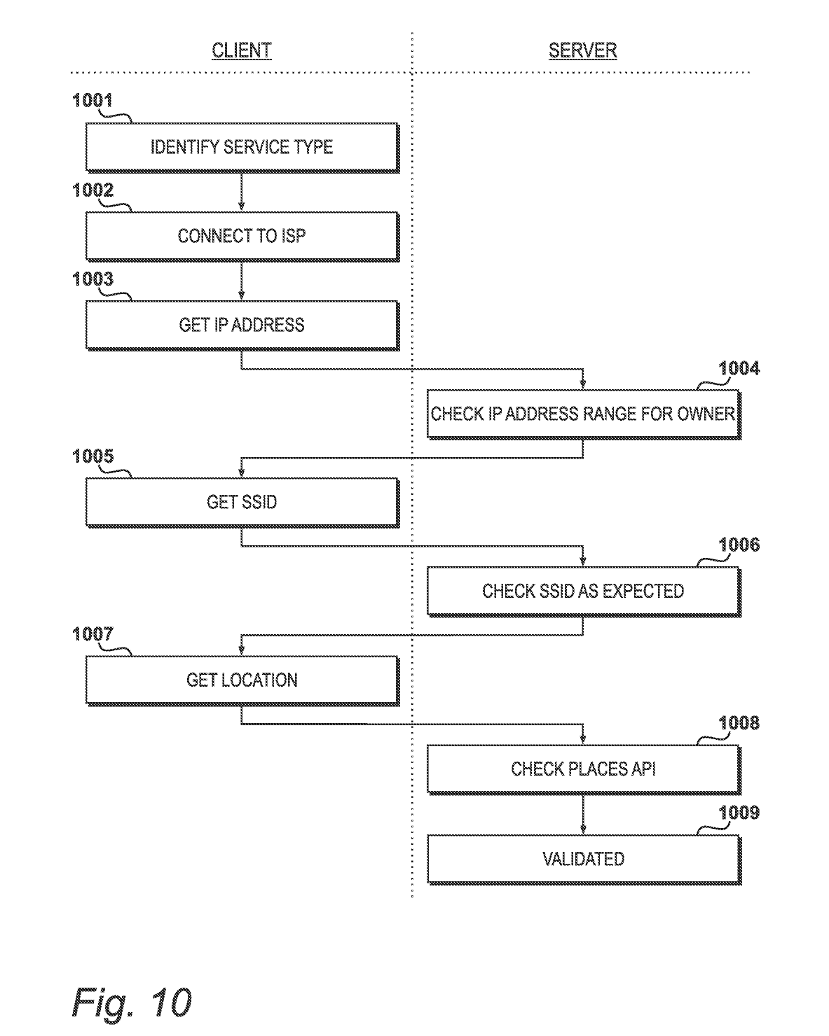

### FIG. 10

The use of such an application is shown in FIG. 10, illustrating the flow of control between a location-aware mobile device (i.e. having GPS functionality, say) running the validation application, and a computer fulfilling the role of either web server 301 or RTB computer 501, in the context of the present invention.

Thus, after the user of the mobile application going to a location that requires validation, at step 1001 the service type is identified by prompting the user to provide input as to what it is. At step 1002 the application running on the mobile device connects to the ISP. At step 1003, the application gets the IP address of the router providing the ISPs Internet services at the location. At step 1004, the server performs a WHOIS lookup on the IP address to find the owner of the IP address. The application then, at step 1005, gets the SSID of the wireless network, which is typically the same for each wireless hotspot provided by the particular ISP identified at step 1004. Thus, at step 1006, the server checks whether that SSID is as expected. At step 1007, the location of the mobile device is identified using GPS or similar, thus providing geolocation data to the server. At step 1008, a Places API lookup is performed using the geolocation data, and if the service type specified by the user is a match for one of the results returned by the Places API lookup, the corresponding record in the second database is amended accordingly and marked as validated.

### FIG. 11

Thus, following the population of the second database, location-aware web serving can be performed when the present invention is deployed in the web server environment identified in FIG. 3.

An overview of procedures carried out by web server 301 using the second database, is therefore illustrated in FIG. 11.

At step 1101, a request for data from a browsing client is received. As will be appreciated by those skilled in the art, using the principles of the present invention, only the Internet-facing IP address of the browsing client need now be known in order to serve location-specific data. Thus, at step 1102, the originating IP address is identified.

The second database 306, now populated with data concerning the nature of the service at the location of the IP address, is then queried at step 1103, thus returning information regarding the service. At step 1104, content is generated dynamically by web server 301 that is specific to that particular location, and at step 1105 it is served to the browsing client.

As will be recognised by those skilled in the art, requests received by web servers from browsing clients using HTTP include a number of details about the browsing client, in addition to simply the IP address to which responses should be sent. Such details include the UserAgent string, which identifies the type of the browser software that is rendering the content, in addition to details about the client operating system and device type. Thus, in an embodiment, during step 1104, dynamic generation of content takes account of the device type and capabilities in addition to its physical location, thus resulting in different content being served to mobile phones and personal computers, even if they are at the same location.

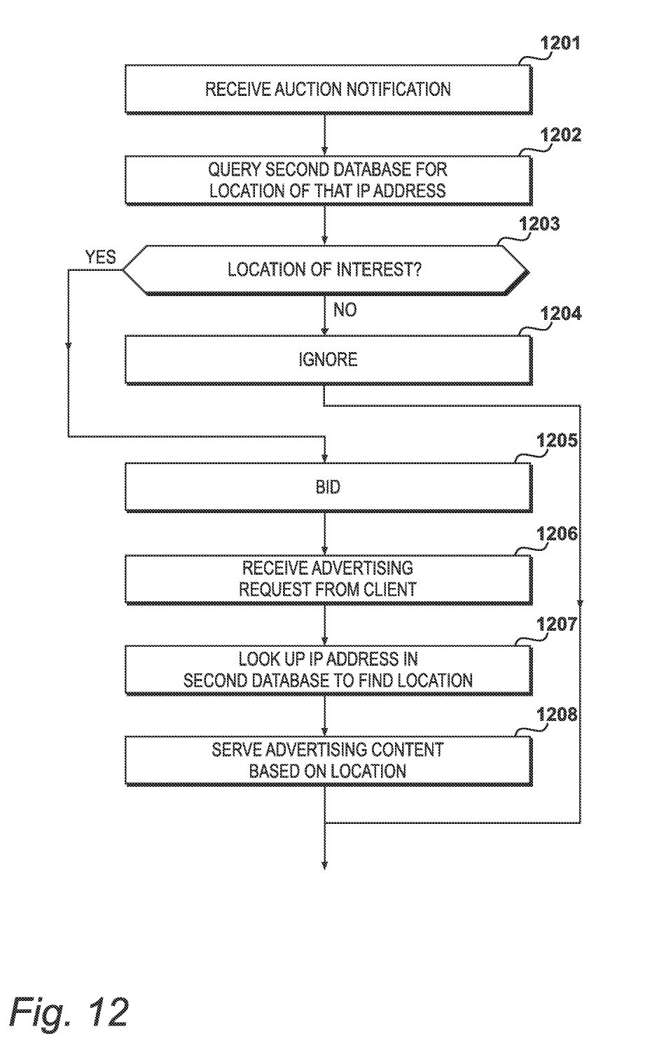

### FIG. 12

As described previously with reference to FIGS. 4 and 5, the principles of the present invention not only have use in a web server environment, but also in a Real Time Bidding environment. The second database created as a result of performing the procedures defined by the present invention allows a much more intelligent methodology for bidding on advertising opportunities presented by an advertising exchange. Thus, in the context of the environment illustrated in FIGS. 4 and 5, the present invention extends to a method of bidding on said opportunities using the second database, stored by the RTB computer 501. Such a method is detailed in FIG. 12, which is described in the context of the environment illustrated in FIG. 4.

At step 1201, an auction notification is received from the advertising exchange 403, which auction notification includes the IP address of the browsing client 401. At step 1202, second database 506 is queried for that IP address. A question is asked at step 1203 as to whether a match has been found, and if answered in the negative, then no bid is entered by ignoring the auction notification at step 1204, as the location of the browsing client cannot be identified. In alternative embodiments, a fixed-price bid of low value could be entered, if it is required.

If the question asked at step 1203 is answered in the affirmative, to the effect that a match was found, the control proceeds to step 1205 where a bid is entered. During this step, a calculation can be made as to what value the bid should have—if the location that the browsing client is evidently at is perceived to be rather exclusive, and its clientele are likely to purchase more exclusive goods, then a higher-value bid can be entered. The algorithm used to calculate the value of the bid will largely be down to the preferences of those implementing the present invention.

Following the entering of a bid at step 1205, either no response will be received within a time-out period (around 100 milliseconds), or a request will be received from the client for advertising content at step 1206. The IP address that they reveal in this request, which possibly is an HTTP request, is then queried against the second database at step 1207. The nature of location returned by the query on the second database then allows the determination of what advertising to serve to the client, at step 1208.

The reason for this double lookup of the IP address in the procedure illustrated in FIG. 12 is that, it is most likely separate processes running on the RTB computer that would be performing the tasks of (a) bidding, and (b) serving advertising.

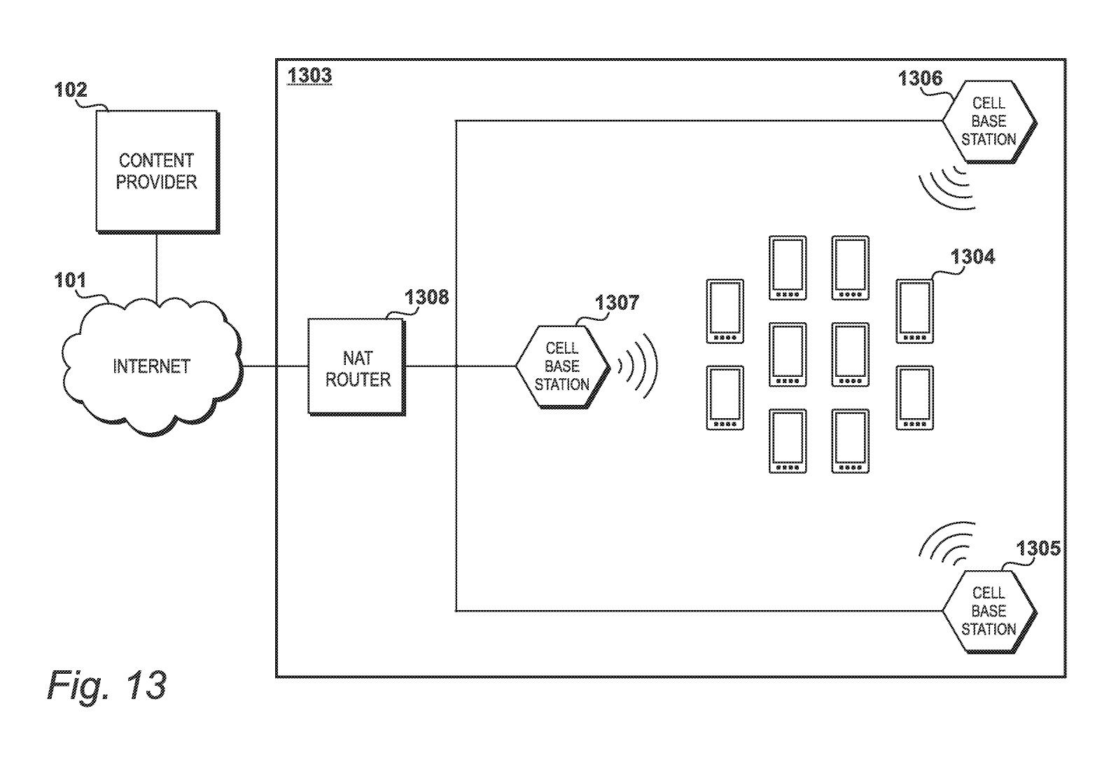

### FIG. 13

Whilst the description of the present invention up until now has been in the context of identifying locations of ISP wireless hotspots, and then serving content of some sort of data to devices at those locations, the present applicant has appreciated that the second database, containing information pertaining to the location of IP addresses, and the services at those locations, also has use for cellular network operators. Such an environment is illustrated in FIG. 13.

Connected to the Internet 101 is content provider 102, along with (in simplified form) a cellular network 1303. Cellular network 1303 provides a cellular connection, such as HSPA or LTE, to a plurality of mobile devices, such as mobile device 1304, by means of a plurality of cellular base stations 1305, 1306 and 1307. Internet connectivity is provided by each cellular base station being connected to the Internet 101 via a Network Address Translation (NAT) router 1308. As described previously, NAT allows a large number of devices (thousands in a cellular network) connected to the router to connect to the Internet, but each one presents one of a small number of IP addresses (less than ten, say) to other devices on the Internet.

Thus, from the perspective of content provider 102, the mobile devices connected to cellular network 1303 all have the same IP address. In other cases, say, half of the mobile devices have one particular IP address, and the other half have another distinct IP address from the perspective of content provider 102.

Thus, the present applicant has appreciated that there exists an opportunity to make use of the second database in order to provide location-aware bidding on advertising opportunities in a Real Time Bidding environment.

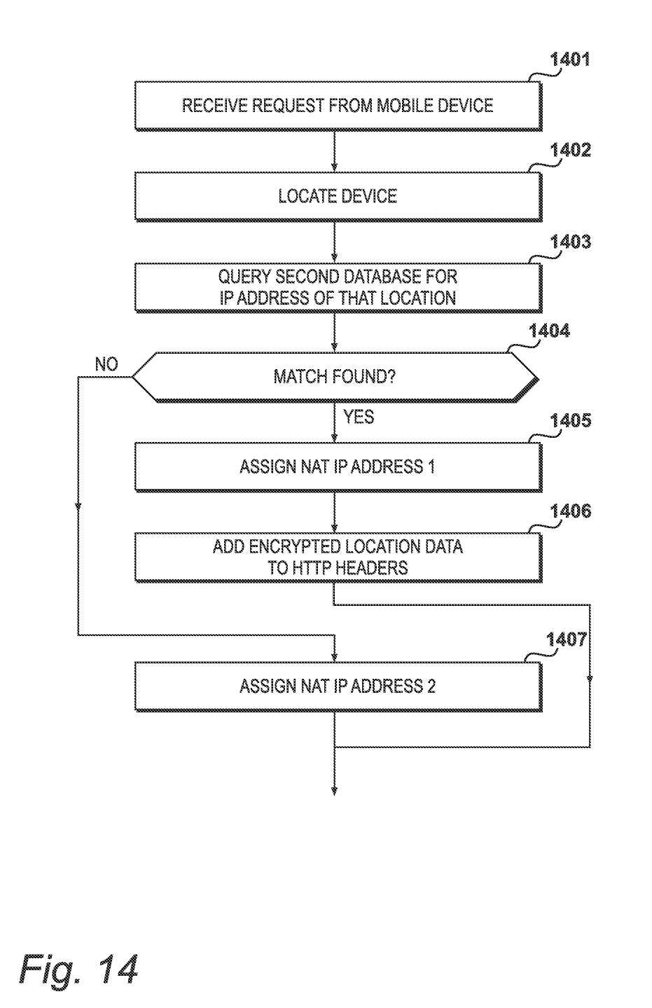

### FIG. 14

Thus, procedures that can be carried out by a server computer under the control of the operator of cellular network 1303 to allow use of location-aware bidding is as follows.

At step 1401, a request is received from the mobile device. At step 1402, the device is located by using multilateration or triangulation techniques, thus producing geolocation data. At step 1403, the second database is then queried to see if the present location of the device matches any validated records.

A question is then asked at step 1404 to ascertain if any matches were found as a result of the query of the second database. If answered in the affirmative, then a NAT IP address 1 is set for the browsing client at step 1405. Such an address will of course be one of the IP addresses in block owned by the cellular network. Following this, at step 1406, the geolocation data produced at step 1402 is encrypted using the assigned IP address, and this encrypted geolocation data is added to all HTTP headers that pass through the cellular network from the browsing client to other hosts on the Internet.

If the question asked at step 1404 was answered in the negative, to the effect that no matches were found in the second database for the browsing client's current position, then control proceeds directly to step 1407 where a NAT IP address 2 is set for the browsing client. Again, this address be one of the IP addresses in block owned by the cellular network, but should be different from the NAT IP address 1 that would have been assigned in step 1405.

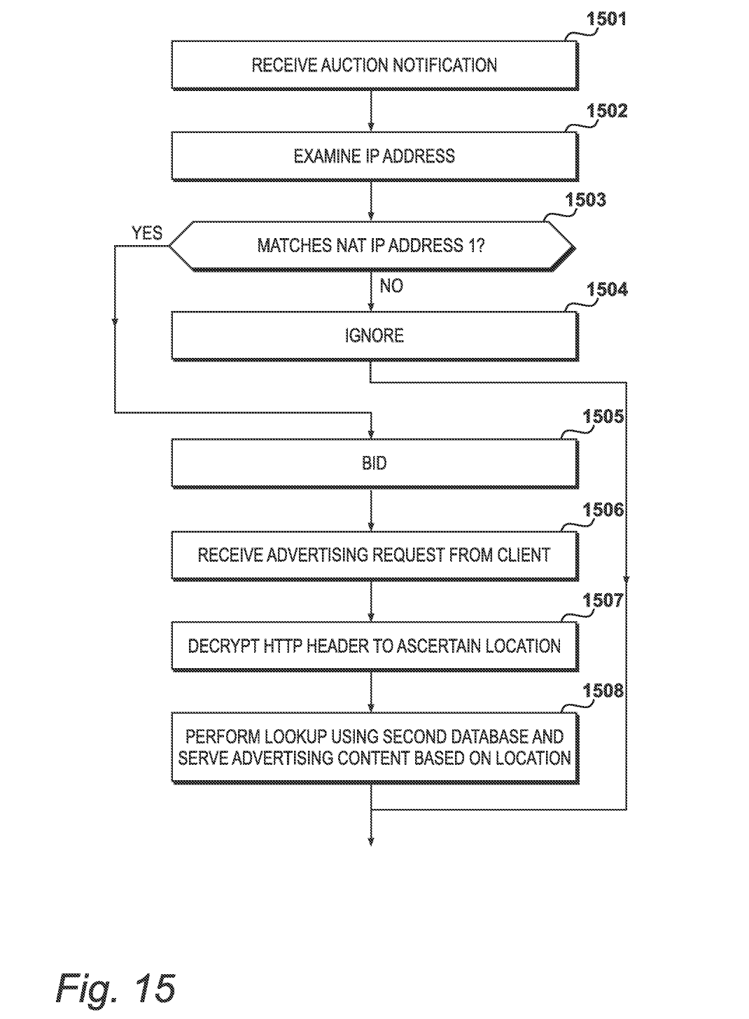

### FIG. 15

Following the assignment of different Internet-facing, NAT IP addresses to browsing clients either in locations that match records in the second database, and those that do not, then bidding on advertising opportunities based on location can be performed. Procedures for bidding in such a way are illustrated in FIG. 15.

At step 1501, an auction notification is received from the advertising exchange 403, which auction notification includes the IP address of the browsing client, say mobile device 1304. A question is then asked at step 1502 as to whether the IP address included in the auction notification matches the IP address assigned to browsing clients in cellular network 1303 who are known to be at a location of interest, i.e. NAT IP address 1. If this question is answered in the negative, then at step 1503 that bidding opportunity is ignored and control returns to step 1501 where the next auction notification is received.

If the question asked at step 1502 is answered in the affirmative, to the effect that the IP address of the browsing client matches NAT IP address 1, then a bid is entered at step 1504 of a value determined by the perceived value of advertising to that browsing client, as described previously. The opportunity will either time out, or, If the bid is successful, a request will be received from the browsing client for advertising data at step 1505. As all traffic to and from the browsing client has injected into its HTTP headers the encrypted location data, then this can now be decrypted and the location identified at step 1506. This then allows querying to take place upon the second database at step 1507 for what the service is at that location, and thus the correct advertising to be served to the client.

What we claim is:

1. Apparatus configured to identify the physical location of internet service providers that each have distinct originating IP addresses, said apparatus comprising a storage device, a network interface, and a processor configured to:
receive a plurality of requests for data from a plurality of locatable browsing clients via said network interface, said requests including an originating IP address corresponding to the internet service provider that each said plurality of browsing clients is connected to, and geolocation data identifying the physical location of each of said plurality of browsing clients;
create and store, in a first database in said storage device, a plurality of records containing said originating IP address and said geolocation data for each of said plurality of request;
perform a query on said first database to identify records where the originating IP addresses match and the geolocation data match within a threshold range;
creating a second database in said storage device, and storing the results of said query in records in said second database.

2. The apparatus of claim 1, wherein said processor is further configured to, for each one of said records in said second database:
perform a lookup using an Internet-based WHOIS service to identify the owner of the IP address stored in the record, and storing the owner data returned in the record;
perform a lookup using an Internet-based place identification service to identify the nature of the service at the location stored in the record, and storing the service data returned in the record; and
marking the record as validated if the results of the lookup operations agree.

3. The apparatus of claim 1, wherein said geolocation data comprises latitude and longitude co-ordinates.

4. The apparatus of claim 3, wherein said threshold range is five metres in both latitude and longitude.

5. The apparatus of claim 1, wherein said plurality of requests for data are received as a consequence of the browsing clients providing geolocation data by interacting with an internet resource that is participating in a Real Time Bidding environment.

6. The apparatus of claim 1, wherein said plurality of requests for data are received as a consequence of the browsing clients providing geolocation data by interacting with an internet resource utilising an implementation of a Geolocation API.

7. The apparatus of claim 1, adapted to operate as a location-aware web server, wherein said processor is further configured to:
receive a request for data from said browsing client via said network interface, said request including the originating IP address of the internet service provider for said browsing client;
perform a query on said second database to identify the geolocation data corresponding to said originating IP address, thereby identifying the physical location of said browsing client;
generate and serve web page data to said browsing client that corresponds to the particular physical location of said browsing client.

8. The apparatus of claim 7, wherein the request for data received from the browsing client includes an indication of the client device type and its software capabilities, and the data served to the client is generated based upon the device type and capabilities in addition to its physical location.

9. The apparatus of claim 1, adapted to operate as a participant in a Real Time Bidding environment, wherein said processor is further configured to:
receive a notification to the effect that an advertising opportunity exists in web page data that is to be served to a browsing client, said notification including the IP address of the internet service provider of the browsing client;
perform a query on said second database to identify the physical location of said originating IP address, thereby identifying the physical location of said browsing client; and
in response to determining that the physical location of said browsing client is a location of interest, enter a bid for advertising to be included in said data to be served to said browsing client.

10. The apparatus of claim 9, wherein said processor is configured to enter a bid having a value that is determined by the perceived value of advertising to a person operating a browsing client at said physical location.

11. A computer-implemented method of identifying the physical location of internet service providers, each of which has a distinct originating IP address, comprising:
receiving a plurality of requests for data from a first plurality of locatable browsing clients, said plurality of requests for data including an originating IP address and geolocation data;
storing records in a first database containing the originating IP address and the geolocation data for each one of said plurality of requests for data;
performing a query on said first database that identifies records where the originating IP addresses match and the geolocation data matches within a threshold range;
storing the results of said query in records in a second database.

12. The method of claim 11, further comprising, for each one of said records in said second database:
performing a lookup using an Internet-based WHOIS service to identify the owner of the IP address stored in the record, and storing the owner data returned in the record;
performing a lookup using an Internet-based place identification service to identify the nature of the service at the location stored in the record, and storing the service data returned in the record
marking the record as validated if the results of the lookup operations agree.

13. The method of claim 11, wherein said geolocation data comprises latitude and longitude co-ordinates.

14. The method of claim 13, wherein said threshold range is five metres in both latitude and longitude.

15. The method of claim 11, wherein said plurality of requests for data are received as a consequence of the locatable browsing clients providing geolocation data by interacting with an internet resource that is participating in a Real Time Bidding environment.

16. The method of claim 11, wherein said plurality of requests for data are received as a consequence of the locatable browsing clients providing geolocation data by interacting with an internet resource utilising an implementation of a Geolocation API.

17. The method of claim 11, in which the second database is used to serve data to a browsing client in a location-aware manner by performing the additional steps of:
receiving a request for data from said browsing client, said request including the originating IP address of the internet service provider for said browsing client;
performing a query on said second database to identify the geolocation data corresponding to said originating IP address, thereby identifying the physical location of said browsing client;
generating and serving data to said browsing client that corresponds to the particular physical location of said browsing client.

18. The method of claim 17, wherein the request for data received from the browsing client includes an indication of the client device type and its software capabilities, and the data served to the client is generated based upon the device type and capabilities in addition to its physical location.

19. A computer-implemented method of bidding on advertising opportunities in a Real Time Bidding environment, comprising:
(i) identifying the physical location of internet service providers, each of which has a distinct originating IP address, by:
receiving a plurality of requests for data from a first plurality of locatable browsing clients, said plurality of requests for data including an originating IP address and geolocation data,
storing records in a first database containing the originating IP address and the geolocation data for each one of said plurality of requests for data,
performing a query on said first database that identifies records where the originating IP addresses match and the geolocation data matches within a threshold range,
storing the results of said query in records in a second database; and
(ii) bidding on an advertising opportunity by:
receiving a notification to the effect that an advertising opportunity exists in data that is to be served to a browsing client, said notification including the IP address of the internet service provider of the browsing client,
performing a query on said second database to identify the geolocation data for said originating IP address, thereby identifying the physical location of said browsing client,
in response to determining that the physical location of said browsing client is a location of interest, entering a bid for advertising to be included in said data to be served to said browsing client.

20. The method of claim 19, wherein the value of the bid entered is determined based upon the perceived value of advertising to a person operating a browsing client at said physical location.
